(19) United States
(12) Patent Application Publication
(10) Pub. No.: US 2020/0260536 A1
(43) Pub. Date: Aug. 13, 2020

(54) METHOD AND DEVICE FOR DETECTING A BOILING STATE OF A LIQUID AND DOMESTIC COOKING APPLIANCE

(71) Applicant: DIEHL AKO STIFTUNG & CO. KG, WANGEN (DE)

(72) Inventors: JOACHIM LYSZUS, BAINDT (DE); MATEUSZ KURPIEL, MARCINOWICE (PL)

(21) Appl. No.: 16/784,559

(22) Filed: Feb. 7, 2020

(30) Foreign Application Priority Data
Feb. 9, 2019 (DE) 10 2019 000 959

(51) Int. Cl. H05B 6/12; H05B 1/02; H05B 6/06; G01H 11/06

(52) U.S. Cl. CPC H05B 6/1209; H05B 1/0266; H05B 2213/07; G01H 11/06; H05B 1/0269; H05B 6/062

(57) ABSTRACT

A method and a device for detecting a boiling state of a liquid and a domestic cooking appliance permit a boiling state of a liquid to be detected during a process of heating the liquid in a heating zone, for example of an induction cooktop. A sensor senses vibrations that are caused during the heating of the liquid in the form of a measuring signal. An evaluation unit converts a time diagram of the sensed measuring signal into a frequency spectrum and then determines the boiling state of the liquid by using an intelligent algorithm on the basis of the frequency spectrum.

### CROSS-REFERENCE TO RELATED APPLICATION

This application claims the priority, under 35 U.S.C. § 119, of German Patent Application DE 10 2019 000 959, filed Feb. 9, 2019; the prior application is herewith incorporated by reference in its entirety.

### BACKGROUND OF THE INVENTION

### Field of the Invention

The present invention relates to a method and a device for detecting a boiling state of a liquid during a process of heating the liquid in a heating zone, in particular a liquid in a cooking vessel in a heating zone of a domestic cooking appliance. The invention also relates to a domestic cooking appliance.

When using conventional domestic cooking appliances, such as in particular cooktops or hobs, the user must personally monitor the heating-up process and the cooking process of an item being cooked in a cooking vessel on a heating zone of the appliance and, if appropriate, manually end or adapt the heating process. In order to improve the safety and the operating convenience for the user, there is the requirement for automatic monitoring and, if appropriate, adaptation of heating processes. For that purpose, it must be possible for the boiling state of the liquid in the cooking vessel to be automatically detected. Various methods for determining a temperature of the cooking vessel or its contents are already known, but still no reliable method for detecting the boiling state of the liquid in the cooking vessel.

### SUMMARY OF THE INVENTION

It is accordingly an object of the invention to provide a method and a device for detecting a boiling state of a liquid during a process of heating the liquid and a domestic cooking appliance, which overcome the hereinafore-mentioned disadvantages of the heretofore-known methods and devices of this general type and with which the boiling state of the liquid can be reliably determined.

With the foregoing and other objects in view there is provided, in accordance with the invention, a method for detecting a boiling state of a liquid during a process of heating the liquid in a heating zone, in which vibrations that are caused during the heating of the liquid are sensed in the form of a measuring signal; a time diagram of the sensed measuring signal is converted into a frequency spectrum; and then the boiling state of the liquid is determined by using an intelligent algorithm on the basis of the frequency spectrum.

The method of the invention senses the vibrations that are caused during the heating of the liquid as a result of the creation and bursting of steam bubbles. A boiling state of the liquid can be detected more accurately and more reliably on the basis of these vibrations than only on the basis of the temperature of the liquid or of the vessel containing the liquid. Furthermore, in the method of the invention, it is not the time diagram of the vibration measuring signal that is evaluated but instead a frequency spectrum, obtained for example by using Fourier transformation. That is to say that the boiling state is not sensed on the basis of the level of the volume of the sensed vibrations, but on the basis of the changing frequency spectrum of the vibrations or vibration levels, which likewise increases the accuracy and reliability of the detection of the boiling state. Finally, the determination of the boiling state of the liquid is performed by using an intelligent algorithm, whereby the accuracy and reliability of the detection of the boiling state can be further increased.

Reliable detection of the boiling state is the prerequisite for the user not to have to personally monitor the heating process, but instead for the heating appliance itself to be able to monitor the boiling state and, if appropriate, automatically change or end the heating process. This increases the convenience of using the heating appliance for the user and also the safety when using the heating appliance.

The boiling state of the liquid includes in this context liquids and liquid-containing mixtures, in particular items being cooked. The heating process includes in this context heating up and boiling of the liquid. The detection of the boiling state includes in this context in particular the detection of whether the liquid has or has not reached its boiling point, but also states before the reaching of the boiling point and beyond the boiling point.

The method of the invention can be applied generally to all types of liquids and to all types of heating processes. The method according to the invention can be applied in particular to liquids in a cooking vessel in a heating zone of a domestic cooking appliance, in particular a cooktop.

The use of an intelligent algorithm includes in this context preferably algorithms that are provided and/or linked with tools of artificial intelligence, such as for example neural networks, expert systems, machine learning and/or fuzzy logic. The intelligent algorithm is preferably self-learning, in order to improve the accuracy and reliability of the detection of the boiling state and to adapt to changing or new application conditions.

In one configuration of the invention, the determination of the boiling state includes a comparison of the frequency spectrum with a set of comparison spectra. The comparison spectra may for example be generated by training of the respective heating appliance or the evaluation unit thereof by the manufacturer and/or the consumer. The comparison spectra may preferably be changed/updated and supplemented. The set of comparison spectra is for example stored in an internal memory of the evaluation unit or of the heating appliance or in an external memory (e.g. cloud, etc.).

The set of comparison spectra preferably contains frequency spectra for different boiling states of a liquid during a heating process. In addition or alternatively, the set of comparison spectra preferably includes frequency spectra for different types of liquid, different amounts of liquid and/or different liquid receiving containers. The more extensive the set of comparison spectra, and the more variables that are taken into account in the various comparison spectra, the more accurate and the more reliable the determination of the boiling state by a comparison of the sensed frequency spectrum with the set of comparison spectra.

In another configuration of the invention, items of heating zone information may also be provided by an appliance controller of one or more heating zones, and the determination of the boiling point by the intelligent algorithm may then also take place on the basis of the items of heating zone information provided. In this way, the accuracy and reliability of the determined boiling state can be further improved. The items of heating zone information include for example items of information about which of a number of heating zones is currently in operation, how intense the heating is, how long the heating has already been performed, and the like. If the heating zone is provided with a temperature sensor, the items of heating zone information may also include items of information about the temperature of the heating zone or for example of the cooking vessel.

In a further configuration of the invention, items of user information can be input by a user by way of parameters that influence the process of heating the liquid, and the determination of the boiling point by the intelligent algorithm can then also take place on the basis of the items of user information input. In this way, the accuracy and reliability of the determined boiling state can be further improved. These items of user information include for example items of information about the type of liquid, the amount of liquid, the size of the vessel containing the liquid, the type of vessel, and the like.

In an added configuration of the invention, after the determination of the boiling state, user feedback concerning a correctness of the determined boiling state may be input by a user. In the case of this configuration, the intelligent algorithm and/or the set of comparison spectra may be adapted to the user feedback input, preferably in a self-learning manner.

Alternatively or in addition, a boiling state of the liquid may additionally be monitored by an optical and/or thermal monitoring unit, which after the determination of the boiling state inputs monitoring feedback concerning a correctness of the determined boiling state. Also in this case, the intelligent algorithm and/or the set of comparison spectra may be adapted to the monitoring feedback input, preferably in a self-learning manner.

In an additional configuration of the invention, after the determination of the boiling state, an information signal is output to a user and/or an item of information and/or a control signal are output to an appliance controller of one or more heating zones. The information signals, items of information and control signals respectively depend on the determined boiling state.

With the objects of the invention in view, there is also provided a device for detecting a boiling state of a liquid during a process of heating the liquid in a heating zone, the device including at least one sensor for sensing vibrations that are caused during the heating of the liquid, in the form of a measuring signal; and an evaluation unit, which is connected to the at least one sensor and has an intelligent algorithm, the evaluation unit being configured for carrying out the method of the invention described above.

With respect to the advantages, preferred configurations and explanations of terms, reference is additionally made to the above statements in connection with the method according to the invention.

The sensor for sensing vibrations that are caused during the heating of the liquid is preferably configured as a vibration sensor, an acceleration sensor such as an accelerometer especially in MEMS (Micro-Electro-Mechanical Systems) technology, a structure-borne vibration sensor or the like. The sensor or sensors may be disposed inside or outside the respective heating appliance; in the case of a cooktop, for example, under the glass ceramic plate or on an extractor or exhaust hood above the cooktop.

The evaluation unit is preferably connected to an appliance controller of the respective heating appliance or is integrated in it.

In one configuration of the invention, the device also has a memory and/or an interface with an external memory for storing a set of comparison spectra, which contains frequency spectra for different boiling states of a liquid during a heating process and/or frequency spectra for different types of liquid, different amounts of liquid and/or different liquid receiving containers.

In one configuration of the invention, the evaluation unit has an interface for receiving items of heating zone information from an appliance controller of one or more heating zones.

In one configuration of the invention, the evaluation unit has an interface for receiving items of user information by way of parameters that influence the process of heating the liquid, and/or user feedback concerning a correctness of the determined boiling state by a user.

In a further configuration of the invention, the device also has an optical and/or thermal monitoring unit that is connected to the evaluation unit for monitoring a boiling state of the liquid.

With the objects of the invention in view there is concomitantly provided a domestic cooking appliance including at least one heating zone, an appliance controller for activating the at least one heating zone, and a device according to the invention as described above for detecting a boiling state of a liquid during a process of heating the liquid in a heating zone. The domestic cooking appliance is for example an (induction) cooktop or a hob.

Other features which are considered as characteristic for the invention are set forth in the appended claims.

Although the invention is illustrated and described herein as embodied in a method and a device for detecting a boiling state of a liquid and a domestic cooking appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. The above and further features and advantages of the invention can be better understood from the following description of preferred, non-restrictive exemplary embodiments on the basis of the accompanying drawing.

### BRIEF DESCRIPTION OF THE SEVERAL VIEWS OF THE DRAWING

FIG. 1 is a diagrammatic, top-plan view of a cooktop or hob with a device for detecting a boiling state of an item being cooked according to the present invention; and

FIG. 2 is a basic diagram for explaining a method for detecting a boiling state of an item being cooked according to the present invention.

### DETAILED DESCRIPTION OF THE INVENTION

The present invention is explained in more detail below by way of example in the case of the application of an (induction) cooktop or hob, without it being intended that the invention is restricted to the application in such domestic cooking appliances or domestic cooking appliances in general.

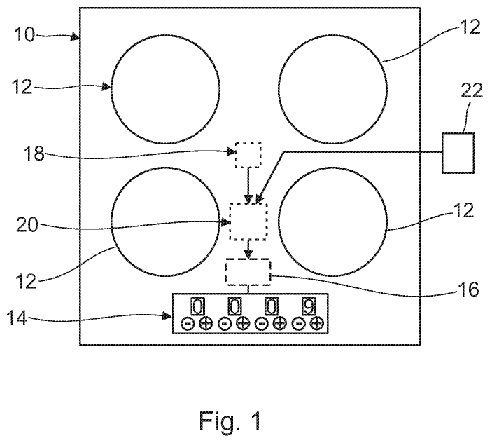

Referring now to the figures of the drawings in detail and first, particularly, to FIG. 1 thereof, there is seen a cooktop 10 which has a plurality of heating zones 12 (four in this exemplary embodiment), an operating device 14 and a cooktop controller (appliance controller in the sense of the invention) 16. The cooktop controller 16 is connected to the operating device 14 and the heating zones 12 and controls the operation of the heating zones according to the settings made by the user by way of the operating device 14.

As indicated in FIG. 1, the cooktop 10 also has at least one sensor 18 for sensing vibrations that are caused during the heating (heating up, cooking, etc.) of an item being cooked in a cooking vessel on one of the heating zones 12 by the creation and bursting of bubbles. The sensor 18 is disposed by way of example under the glass ceramic plate of the cooktop 10, in the middle region between the four heating zones 12. The sensor 18 is for example a vibration sensor, an acceleration sensor such as an accelerometer especially in MEMS (Micro-Electra-Mechanical Systems) technology, a structure-borne vibration sensor or the like.

The at least one sensor 18 is connected to an evaluation unit 20 (in a wireless or wired manner). This evaluation unit 20 is configured to detect, on the basis of the measuring signal sensed by the sensor 18, a boiling state of an item being cooked on the cooktop 10 according to the method described below. The evaluation unit 20 is connected to the cooktop controller 16 (in a wireless or wired manner) or is integrated in the cooktop controller 16.

Optionally, the cooktop 10 is additionally provided with a thermal and/or optical monitoring unit 22, which can thermally and/or optically monitor the boiling state of an item being cooked on the cooktop 10. The monitoring unit 22 may for example be attached to an extractor or exhaust hood above the cooktop 10. The monitoring unit 22 is likewise connected to the evaluation unit 20 (in a wireless or wired manner).

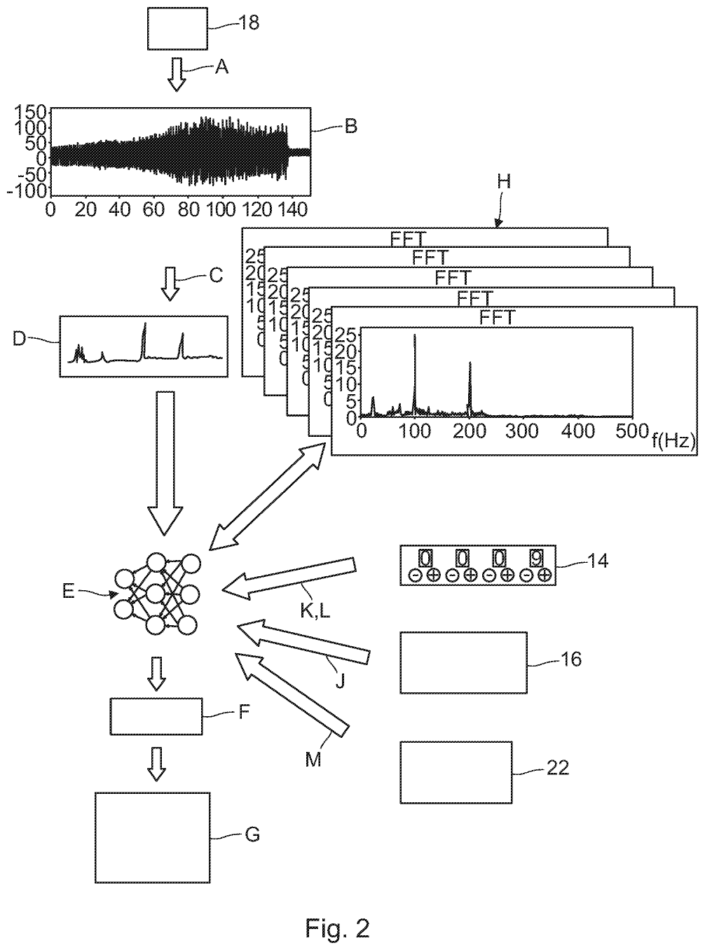

FIG. 2 illustrates by way of example the principle of a method according to the invention for detecting a boiling state of an item being cooked on the cooktop 10.

The at least one sensor 18 senses the vibrations of the item being cooked during the heating process in the form of a measuring signal A, which it transmits to the evaluation unit 20. The measuring signal A is first recorded in the form of a time diagram B, that is to say as a vibration level/time diagram. This time diagram B is converted by the evaluation unit 20 by using a Fourier transformation C into a frequency spectrum D, that is to say into a vibration level/frequency diagram.

During the heating (up) of a liquid or of a liquid-containing mixture, the vibrations caused by the creation, rising up and bursting of steam bubbles not only become louder (that is to say there is an increasing vibration level) as the temperature increases. During heating of the liquid, the vibrations also change in the various phases of the heating-up and cooking process and the vibrations differ according to the type and amount of the liquid and according to the type and size of the cooking vessel. Therefore, shortly before reaching the boiling point, usually a typical boiling vibration occurs with a high-frequency hissing, which is overlaid with low-frequency vibrations as a result of the bursting of the steam bubbles and vibrations of the cooking vessel during the transition to boiling. The amount and type of liquid to be heated up and the proportion of liquid in the item being cooked that is to be heated up also influence the volume and the type of vibrations. The vibrations generated also depend on the material and the size of the cooking vessel and the presence or absence of a lid on the cooking vessel.

The frequency spectrum D of the sensed measuring signal A is then evaluated by an intelligent algorithm E of the evaluation unit 20. The intelligent algorithm in this case, preferably uses tools of artificial intelligence, such as for example neural networks, expert systems, machine learning and/or fuzzy logic. Furthermore, this intelligent algorithm is preferably configured as self-learning, in order to be able if appropriate to correct its functional mode and adapt itself to changing or new application conditions.

The evaluation unit 20 determines, by using the intelligent algorithm on the basis of the frequency spectrum D, the boiling state of the item being cooked (boiling state determination F). Depending on the determined boiling state, there are then various reactions G, which are initiated by the evaluation unit 20. The reactions include in particular—depending on the determined boiling state—information signals for the user, which are sent to the operating device 14 and/or a mobile device of the user (e.g. smartphone), in order to generate corresponding optical and/or acoustic signals for the user, and items of information and/or control signals to the cooktop controller 16, in order to change the activation of the heating zones 12 (e.g. switch off heating, reduce heating output, increase heating output, etc.).

If, for example, the user receives, on the operating device 14 of the cooktop 10 or on his/her smartphone, items of information about the current boiling state of the item being cooked, he/she can react to this information. For example, after boiling of the water in a cooking pot is achieved, a further item to be cooked, such as for example noodles, can be introduced into the boiling water. The user does not have to stay at the cooktop the whole time, but can use the time for a heating-up process for other tasks until he/she is correspondingly informed by the evaluation unit 20.

On the other hand, a cooking process can be automated if items of information and/or control signals are transmitted to the cooktop controller 16, so that, according to requirements, the cooktop controller 16 ends or adapts the heating process. For example, after achieving boiling of the liquid (for example soup), the cooktop controller may reduce the heating output of the corresponding heating zone 12, in order to allow the liquid to continue being cooked with lower heat, or reduce or end the heating output of the corresponding heating zone 12, in order to prevent overcooking of the item being cooked. The user therefore does not have to stay at the cooktop the whole time during the heating-up and cooking, but can use the time for other tasks until he/she is correspondingly informed by the evaluation unit 20.

As illustrated in FIG. 2, the boiling state determination F is performed by the intelligent algorithm E with the aid of a set of comparison spectra H. The set H is for example stored in an internal memory of the evaluation unit 20 or in an external memory (e.g. cloud, etc.). It contains frequency spectra for different boiling states of a liquid during a heating process and for different types of liquid, different amounts of liquid and/or different liquid receiving containers. The set of comparison spectra H was for example generated and stored by the manufacturer of the cooktop 10 as a training set. Alternatively or in addition, the training set may also be generated by the user of the cooktop 10. Preferably, the set H or its frequency spectra can be adapted, corrected and extended by the intelligent algorithm E of the evaluation unit. The frequency spectra D, H are compared with one another, for example in a frequency range from approximately 0 to 500 Hz. However, the frequency range to be evaluated is not restricted to these numerical values and may in particular also include higher frequencies of up to 1000 Hz or of up to 5000 Hz.

The intelligent algorithm E determines the current boiling state of the item being cooked by a comparison of the frequency spectrum D generated from the measuring signal A with the set of comparison spectra H. That is to say that the algorithm determines which of the comparison spectra of the set H is most similar to the current frequency spectrum D.

In order to make the result of the comparison more accurate and more reliable, items of heating zone information J are preferably also transmitted to the algorithm by the cooktop controller 16. These items of heating zone information J include for example items of information about which of the heating zones is in operation, which of the heating zones has already been in operation for how long and with what heating output, which of the heating zones are occupied by a cooking vessel, and the like. If the heating zones 12 are also provided with temperature sensors, the items of heating zone information may also include items of information about the temperature of the heating zone 12 or of the cooking vessel.

In order to make the result of the comparison more accurate and more reliable, items of user information K are preferably also input to the algorithm by the user by way of the operating device 14. These items of user information K include for example items of information about the type of item being cooked, the amount of the item being cooked, the type of cooking vessel (pot, pan, etc.), the size of the cooking vessel, the material of the cooking vessel (cast iron, aluminium, etc.), the presence or absence of a lid on the cooking vessel and the like.

On the basis of the additional items of heating zone information J and items of user information K, the intelligent algorithm can for example select from the stored set of comparison spectra H a subgroup of comparison spectra that match the current parameters of the item being cooked that is to be heated, in order then to compare the frequency spectrum D of the measuring signal A only with this subgroup of comparison spectra.

In order to improve further the quality of the boiling state determination F, the intelligent algorithm E and the set of comparison spectra H may be adapted/corrected/improved in a self-learning way.

For this purpose, after the boiling state determination F has been completed, user feedback L concerning the actual boiling state of the item being cooked or the correctness of the boiling state determination F may be input to the intelligent algorithm E of the evaluation unit 20, for example by the user by way of the operating device 14. That is to say that the intelligent algorithm E can check or find out whether its boiling state determination F was correct or erroneous. In the case of an erroneous boiling state determination F, the algorithm E can then, if appropriate, correct its functional mode and/or correct or extend the comparison spectra of the set H. In this way, the results of the subsequent determinations of the boiling state F by the evaluation unit 20 can be improved.

Optionally, once the boiling state determination F has been completed, monitoring feedback M about the actual boiling state of the item being cooked may additionally be input to the intelligent algorithm E of the evaluation unit 20 by a monitoring unit 22, if such a monitoring unit 22 is present. Also in this variant, the intelligent algorithm E can then check whether its boiling state determination F was correct or erroneous and, in the case of an erroneous boiling state determination F, can then, if appropriate, correct its functional mode and/or correct or extend the comparison spectra of the set H, in order in this way to improve the results of the subsequent determinations of the boiling state F by the evaluation unit 20.

### LIST OF REFERENCE NUMERALS

10 Domestic cooking appliance, in particular (induction) cooktop
12 Heating zone
14 Operating device
16 Appliance controller, in particular cooktop controller
18 Sensor
20 Evaluation unit
22 Monitoring unit
A Measuring signal
B Time diagram
C Fourier transformation
D Frequency spectrum
E Intelligent algorithm
F Boiling state determination
G Reaction to specific boiling state
H (Training) set of comparison spectra
J Items of heating zone information
K Items of user information
L User feedback
M Monitoring feedback

1. A method for detecting a boiling state of a liquid during a process of heating the liquid in a heating zone, the method comprising the following steps:
sensing vibrations caused during the heating of the liquid and providing a measuring signal;
converting a time diagram of the sensed measuring signal into a frequency spectrum; and
determining the boiling state of the liquid by using an intelligent algorithm based on the frequency spectrum.

2. The method according to claim 1, which further comprises carrying out the step of determining the boiling state by performing a comparison of the frequency spectrum with a set of comparison spectra containing frequency spectra for different boiling states of a liquid during the heating process.

3. The method according to claim 1, which further comprises carrying out the step of determining the boiling state by performing a comparison of the frequency spectrum with a set of comparison spectra containing frequency spectra for at least one of different types of liquid, different amounts of liquid or different liquid receiving containers.

4. The method according to claim 1, which further comprises using an appliance controller of one or more heating zones to provide items of heating zone information, and carrying out the step of determining the boiling point by the intelligent algorithm based on the provided items of heating zone information.

5. The method according to claim 1, which further comprises carrying out the step of determining the boiling point by the intelligent algorithm based on items of user information input by a user by way of parameters influencing the process of heating the liquid.

6. The method according to claim 2, which further comprises adapting at least one of the intelligent algorithm or the set of comparison spectra to user feedback input by a user concerning a correctness of the determined boiling state.

7. The method according to claim 1, which further comprises:
using at least one of an optical or thermal monitoring unit to additionally monitor the boiling state of the liquid;
after carrying out the step of determining the boiling state, using the monitoring unit to input monitoring feedback concerning a correctness of the determined boiling state; and
adapting at least one of the intelligent algorithm or the set of comparison spectra to the input monitoring feedback.

8. The method according to claim 1, which further comprises after carrying out the step of determining the boiling state, at least one of:
outputting an information signal to a user, or
outputting at least one of an item of information or a control signal to an appliance controller of one or more heating zones.

9. The method according to claim 1, which further comprises carrying out the step of sensing vibrations by using a vibration sensor.

10. The method according to claim 1, which further comprises carrying out the step of sensing vibrations by using an accelerometer.

11. A device for detecting a boiling state of a liquid during a process of heating the liquid in a heating zone, the device comprising:
at least one sensor for sensing vibrations caused during the heating of the liquid and for providing a measuring signal having a time diagram; and
an evaluation unit connected to said at least one sensor, said evaluation unit having an intelligent algorithm, and said evaluation unit being configured for:
converting said time diagram of said sensed measuring signal into a frequency spectrum; and
determining the boiling state of the liquid by using said intelligent algorithm based on said frequency spectrum.

12. The device according to claim 11, which further comprises at least one of a memory or an interface with an external memory for storing a set of comparison spectra containing at least one of frequency spectra for different boiling states of a liquid during a heating process or frequency spectra for at least one of different types of liquid, different amounts of liquid or different liquid receiving containers.

13. The device according to claim 11, which further comprises an appliance controller of one or more heating zones, said evaluation unit having an interface for receiving items of heating zone information from said appliance controller.

14. The device according to claim 11, wherein said evaluation unit has an interface for receiving items of user information by way of at least one of parameters influencing the process of heating the liquid or user feedback concerning a correctness of the determined boiling state by a user.

15. The device according to claim 11, which further comprises at least one of an optical or thermal monitoring unit connected to said evaluation unit for monitoring a boiling state of the liquid.

16. The device according to claim 11, wherein said at least one sensor is a vibration sensor.

17. The device according to claim 11, wherein said at least one sensor is an accelerometer.

18. A domestic cooking appliance, comprising:
at least one heating zone;
an appliance controller for activating said at least one heating zone; and
a device according to claim 11 for detecting a boiling state of a liquid during a process of heating the liquid in a heating zone.
